(19) United States
(12) Patent Application Publication
(10) Pub. No.: US 2007/0142507 A1
(43) Pub. Date: Jun. 21, 2007

(54) Solvent-based coating compositions

(76) Inventors: Josef Huybrechts, Turnhout (BE); Carmen Flosbach, Wuppertal (DE); Ann Vaes, Koningshooikt (BE); Eline de Rouck, Zottegem (BE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/311,968

(22) Filed: Dec. 20, 2005

(51) Int. Cl. C08L 95/00

(52) U.S. Cl. 524/69; 524/221; 524/272; 524/310; 524/560; 524/563; 524/513

(57) ABSTRACT

A solvent-based coating composition, used in automotive original and automotive refinish coating, comprising 10-90% by weight of at least one hydroxyl-functional (meth)acrylic copolymer A) having an OH value from 80 to 200 KOH/g and a weight average molecular weight Mw from 2,500 to 30,000 and 90-10 weight.-% of at least one cross-linking agent B), which is capable of entering into a cross-linking reaction with the OH-groups of components A), wherein the % by weight of component A) and B) add up to 100 weight.-%, wherein the hydroxyl-functional (meth)acrylic copolymer A) is obtained by reacting a group of components, comprising
a) 15-50% by weight of at least one hydroxy functional free-radically copolymerizable olefinically unsaturated monomer,
b) 30-80% by weight of at least one non-hydroxy functional polymerisable unsaturated monomer and
5-40% by weight of at least one lactone compound, and
wherein the hydroxy-functional (meth)acrylic copolymer A) is prepared by reacting monomers a), b) and c) in a skew feed polymerization process, with at least two feed streams.

### FIELD OF THE INVENTION

The invention relates to solvent-based one- or two-component coating compositions comprising hydroxy-functional lactone-modified (meth)acrylic copolymers and hardeners. The coating compositions are useful for automotive and industrial coatings.

### DESCRIPTION OF RELATED ART

In automotive coatings in particular, there is a need for one- and two-component coating compositions which produce scratch resistant and chemical resistant coatings. It is already known from the prior art to use hydroxy-functional (meth)acrylic copolymers whose hydroxyl groups are modified with lactones. Those (meth)acrylic copolymers are prepared in a one-step process.

For example, coating compositions for automotive coatings that are based on lactone-modified (meth)acrylic copolymers and polyisocyanate cross-linking agents are described in EP-A-1 227 113. The (meth)acrylic copolymers are prepared from pre-adducts of lactones and hydroxyalkyl(meth)acrylates and additional unsaturated monomers.

U.S. Pat. No. 3,892,714 describes hydroxyfunctional (meth)acrylic copolymers with main and side chains whereby the main chains comprise a copolymer of ethylenically unsaturated monomers, at least one of which contains hydroxyl groups, and the side chains comprise lactone chains attached to said hydroxyl groups.

EP 1 454 934 describes hydroxyfunctional (meth)acrylic copolymers obtained by free-radically copolymerizing a monomer mixture of hydroxy functional and non-hydroxy functional olefinically unsaturated monomers, whereby at least part of the hydroxyl groups of the hydroxy-functional (meth)acrylic copolymer are reacted with a lactone compound. whereby at least part of the hydroxyl groups of the hydroxy-functional (meth)acrylic copolymer are reacted with a lactone compound.

Disadvantages of those coating compositions are an unsatisfactory balance between early hardness development and scratch resistance of coatings derived from the coating compositions.

Accordingly, there is a need for automotive and industrial coating compositions, in particular for automotive clear coat compositions and pigmented monocoat compositions which lead not only to coatings having a very good scratch resistance but also meet requirements for excellent physical drying properties and hardness, especially after drying at relatively low temperatures (e.g. below 80° C.). In addition, the resultant coatings shall have a very good appearance.

### SUMMARY OF THE INVENTION

The invention is directed to solvent-based coating compositions having a resin solids, said resin solids comprising
A) 10-90% by weight of at least one hydroxyl-functional (meth)acrylic copolymer having preferably, an OH value from 80 to 200 KOH/g, more preferred from 150 to 190 mg KOH/g and a weight average molecular weight Mw from 2,500 to 30,000, more preferred from 3,000 to 20,000 and
B) 90-10% by weight of at least one cross-linking agent which is capable of entering into a cross-linking reaction with the OH-groups of components A), wherein the % by weight of components A) and B) add up to 100% by weight, and
wherein the hydroxyl-functional (meth)acrylic copolymer A) is obtained by reacting a group of momomers, comprising
   a) 15-50% by weight, preferably, 30-40% by weight, of at least one hydroxy functional free-radically copolymerizable olefinically unsaturated monomer,
   b) 30-80% by weight, preferably, 40-70% by weight of at least one non-hydroxy functional polymerisable unsaturated monomer and
   c) 5-40% by weight, preferably, 10-30% by weight of at least one lactone compound, wherein the % by weight of monomers a), b) and c) add up to 100% by weight, and
wherein the hydroxy-functional (meth)acrylic copolymer A) is prepared by reacting monomers a), b) and c) in a skew feed polymerization process with at least two feed streams, wherein in a first stage a monomer mixture I) comprising 30-40% by weight of monomers a), 40-70% by weight of monomers b) and 10-30% by weight of compounds c) is reacted, wherein the % by weight of components a), b) and c) are based on the entire amount of monomer mixture 1) used in the first stage add up to 100% by weight,
and wherein in a second stage a monomer mixture II) comprising 30-50% by weight of monomers a) and 40-70% by weight of monomers b) are polymerized in presence of the (meth)acrylic copolymer obtained in the first stage, wherein the % by weight of components a) and b) are based on the entire amount of monomer mixture II) used in the second stage add up to 100% by weight.

Optionally, up to 30% by weight of component c), based on the entire amount of components a), b) and c) used in the second stage.

Preferably, the hydroxy-functional (meth)acrylic copolymer contains non-hydroxy functional polymerisable unsaturated monomers b) comprising b1) at least one alkyl ester of an olefinically unsaturated carboxylic acid with 2-12 C atoms in the alkyl residue, b2) at least one vinylaromatic olefinically unsaturated monomer, b3) at least one unsaturated acid functional monomer and optionally b4) at least one other polymerisable unsaturated monomer which is different from components b1) to b3). Especially preferred monomers b) consist of 10-90% by weight, preferably, 20-80% by weight, of component b1), 0-50% by weight, preferably, 10-40% by weight, of component b2), 0-10% by weight, preferably, 2-6% by weight, of component b3), 0-30% by weight, preferably, 0-20% by weight, of component b4), wherein the % by weight of components b1) to b4) add up to 100% by weight.

### DETAILED DESCRIPTION OF THE EMBODIMENTS

The term (meth)acrylic as used here and hereinafter should be taken to mean methacrylic and/or acrylic.

Unless stated otherwise, all molecular weights (both number average molecular weight Mn and weight average molecular weight Mw) referred to herein are determined by GPC (gel permeation chromatographie) using polystyrene as the standard.

The glass transition temperature (Tg) of the copolymers has been calculated from the glass transition temperature of the homopolymers of the monomers according to the Flory-Fox equation. Glass transition temperatures of the homopolymers have been used measured by differential scanning calorimetry (DSC).

The present invention is directed to solvent-based coating compositions. Solvent-based coating compositions are coating compositions, wherein one or more organic solvents-are used as solvent or thinner when preparing and/or applying the coating composition.

Surprisingly, it was found that hydroxy-functional (meth)acrylic copolymers prepared according to the present invention, when used in coating compositions with isocyanate-crosslinker, form coatings having in particular a good balanced ratio among excellent scratch resistance, good hardness and good physical drying performance.

In the following, the invention will be described in more detail.

Preferably the hydroxy-functional (meth)acrylic copolymer A) is obtained by reacting a group of components comprising
a) 15-50% by weight, preferably, 30-40% by weight, of at least one hydroxy functional free-radically copolymerizable olefinically unsaturated monomer,
b1) 0-50% by weight, preferably, 10-40% by weight, of at least one alkyl ester of an olefinically unsaturated carboxylic acid with 2-12 C atoms in the alkyl residue
b2) 0-50% by weight, preferably, 10-40% by weight, of at least one vinylaromatic olefinically unsaturated monomer
b3) 0-8% by weight, preferably, 1-5% by weight, of at least unsaturated acid functional monomer and
b4) 0-50% by weight, preferably, 0-40% by weight, of at least one other polymerisable unsaturated monomer which is different from components b1) to b3), wherein b1)-b4) comprise 30-80% by weight of copolymer A,
c) 5-40% by weight, preferably, 10-30% by weight of at least one lactone compound, wherein the % by weight of monomers a), b1) to b4) and c) add up to 100% by weight, and
   wherein the hydroxy-functional (meth)acrylic copolymer A) is prepared by a skew feed polymerization process with at least two feed streams, wherein in a first stage a monomer mixture I) is polymerized, said monomer mixture I) comprises
Ia) 15-50% by weight, preferably, 30-40% by weight, of at least one hydroxy functional free-radically copolymerizable olefinically unsaturated monomer,
Ib1) 0-50% by weight, preferably, 10-40% by weight, of at least one alkyl ester of an olefinically unsaturated carboxylic acid with 2-12 C atoms in the alkyl residue
Ib2) 0-50% by weight, preferably, 10-40% by weight, of at least one vinylaromatic olefinically unsaturated monomer and
Ib4) 0-50% by weight, preferably, 0-40% by weight, of at least one other polymerisable unsaturated monomer which is different from components Ia) to Ib2), wherein Ib1)-Ib4) monomer comprise 40-70% by weight of the first stage monomer mixture I),
Ic) 5-40% by. weight, preferably, 10-30% by weight of at least one lactone compound, wherein the % by weight of monomers Ia), Ib1) to Ib4) and Ic) add up to 100% by weight, and
   wherein in a second stage a monomer mixture II) is polymerized in presence of the copolymer obtained in the first stage, said monomer mixture II) comprises
IIa) 20-70% by weight, preferably, 30-60% by weight, of at least one hydroxy functional free-radically copolymerizable olefinically unsaturated monomer,
IIb1) 10-70% by weight, preferably, 20-60% by weight, of at least one alkyl ester of an olefinically unsaturated carboxylic acid with 2-12 C atoms in the alkyl residue,
IIb3) 0-20% by weight, preferably, 2-15% by weight, of at least one unsaturated acid functional monomer and
IIb4) 0-50% by weight, preferably, 0-20% by weight, of at least one other polymerisable unsaturated monomer which is different from components IIb1) to IIb3), wherein IIb1)-IIb4) monomer comprise 40-70% by weight of the second stage monomer mixture II),
IIc) 0-30% by weight of at least one lactone compound,
   wherein the % by weight of components IIa), IIb1) to IIb4) and IIc) is adding up to 100% by weight.

The hydroxy-functional (meth)acrylic copolymers A) comprise components a) to c), preferably the hydroxy-functional (meth)acrylic copolymers A) consist of components a) to c) in the ratio by weight as mentioned above.

Examples of suitable hydroxy-functional olefinically unsaturated monomers (component a) are hydroxyalkyl esters of alpha, beta-olefinically unsaturated monocarboxylic acids having primary or secondary hydroxyl groups. Examples include the hydroxyalkyl esters of acrylic acid, methacrylic acid, crotonic acid and/or itaconic acid. The hydroxyalkyl esters of (meth)acrylic acid are preferred. The hydroxyalkyl radicals may contain, for example, 1 to 10 carbon atoms, preferably 2 to 6 carbon atoms. Examples of suitable hydroxyalkyl esters of alpha, beta-olefinically unsaturated monocarboxylic acids having primary hydroxyl groups are hydroxyethyl(meth)acrylate, 2,3-hydroxypropyl(meth)acrylate, 2- and 4-hydroxybutyl(meth)acrylate, hydroxyamyl(meth)acrylate, and hydroxyhexyl(meth)acrylate. Examples of suitable hydroxyalkyl esters having secondary hydroxyl groups are 2-hydroxypropyl(meth)acrylate, 2-hydroxybutyl(meth)acrylate, and 3-hydroxybutyl(meth)acrylate.

Further hydroxy-functional unsaturated monomers which may be used are reaction products of alpha, beta-unsaturated monocarboxylic acids with glycidyl esters of saturated monocarboxylic acids branched in the alpha position, e.g., with glycidyl esters of saturated alpha-alkylalkane monocarboxylic acids or alpha,alpha′-dialkylalkane monocarboxylic acids. These are preferably the reaction products of (meth)acrylic acid with glycidyl esters of saturated alpha,alpha′-dialkylalkane monocarboxylic acids having 7 to 13 carbon atoms in the molecule, particularly preferably having 9 to 11 carbon atoms in the molecule. Other hydroxy-functional unsaturated monomers are polyethylene oxide and/or polypropylene oxide modified (meth)acrylates.

Non-hydroxy functional monomers b) may contain apart from an olefinic double bond further functional groups or may contain apart from an olefinic double bond no further functional groups. Component b) comprises monomers b1) to b4) as described above.

Examples of suitable esters of olefinically unsaturated carboxylic acids (component b1) are esters of olefinically unsaturated carboxylic acids with aliphatic and/or cycloaliphatic alcohols. Examples of suitable olefinically unsaturated carboxylic acids include acrylic acid, methacrylic acid, crotonic acid and isocrotonic acid. The alcohols are, in particular, aliphatic monohydric branched or unbranched alcohols having 1-20 carbon atoms in the molecule. Examples of (meth)acrylates with aliphatic alcohols are methyl acrylate, ethyl acrylate, isopropyl acrylate, tert.-butyl acrylate, n-butyl acrylate, isobutyl acrylate, 2-ethylhexyl acrylate, lauryl acrylate, stearyl acrylate and the corresponding methacrylates.

The alcohols may also be cycloaliphatic monohydric branched or unbranched alcohols having 1-20 carbon atoms in the molecule. The substituents are, for example, one or more, e.g., up to three alkyl groups, particularly those having 1-4 carbon atoms. Examples of (meth)acrylates with cycloaliphatic alcohols are cyclohexyl acrylate, trimethylcyclohexyl acrylate, 4-tert.butylcyclohexyl acrylate, isobornyl acrylate and the corresponding methacrylates. The (cyclo)aliphatic(meth)acrylates may also be substituted.

Examples of vinylaromatic olefinically unsaturated monomers (component b2) are those having 8-12 carbon atoms in the molecule. Preferred examples of such monomers are styrene, alpha-methylstyrene, chlorostyrenes, vinyltoluenes, 2,5-dimethylstyrene, p-methoxystyrene and tertiary-butylstyrene. Most preferred styrene is used as component c).

Examples of suitable olefinically unsaturated carboxylic acids (component b3) include acrylic acid, methacrylic acid, crotonic acid and isocrotonic acid. Acrylic and methacrylic acid are preferred.

The other olefinically unsaturated monomers capable of radical polymerization (component b4) are any olefinically unsaturated monomers capable of free-radical polymerization, which are different from components a) to b3). Examples of suitable components b4) are vinyl esters, e.g. vinyl acetate, vinyl propionate and vinyl esters of saturated monocarboxylic acids branched in the alpha position, e.g., vinyl esters of saturated alpha,alpha′-dialkylalkane monocarboxylic acids and vinyl esters of saturated alpha-alkylalkane monocarboxylic acids having in each case 5-13 carbon atoms, preferably 9-11 carbon atoms in the molecule. Examples of other suitable unsaturated monomers b4) are urea, amine, amide, acetoacetate, sulfonic acid, silane and imidazole functional unsaturated monomers as ethyleneurea ethyl(meth)acrylate, dimethylaminoethyl(meth)acrylate, acetoacetoxyethyl(meth)acrylate, (meth)acrylamide, alkoxy methyl(meth)acrylamides, vinyl silane, methacryloxyethyl trialkoxysilanes, acrylamido 2—methyl propane, sulfonic acid, vinyl imidazole. Furthermore it is possible to use monomers having more than 1, e.g. 2 olefinic double bonds in the molecule.

According to the invention it is essential to use the at least one lactone compound (component c). The hydroxyl groups of the hydroxy-functional (meth)acrylic copolymers A), preferably the hydroxyl groups of the hydroxy-functional (meth)acrylic copolymer I obtained in step I are at least partly modified with the at least one lactone compound (component c).

Examples of suitable lactone compounds (component c) are those containing 3 to 15 carbon atoms in the ring and where the rings may also have various substituents. Preferred lactones are gamma butyrolactone, delta valerolactone, epsilon caprolactone, beta-hydroxy-beta-methyl-delta valerolactone, lambda laurinlactone or mixtures thereof. Epsilon caprolactone is particularly preferred.

It is also essential for the present invention to prepare the hydroxy-functional (meth)acrylate copolymers A) by a skew feed polymerization process with at least two feed streams, preferably with two feed streams. The hydroxy-functional (meth)acrylate copolymers A) are obtained by reacting in a first stage monomer mixture I and by copolymerizing in a second stage monomer mixture II in presence of the copolymer obtained in first stage. The total amount of unsaturated monomers a) and b) can be varied between the first and second feed streams, but it is essential that the first feed stream comprises the lactone compound c). The first feed stream can contain for example, 70-100% by weight of the lactone compounds c), based on-the entire amount of lactone compounds c).

The first feed stream comprises for example, 40-80% by weight of the total amount of monomers a) and b) and the second feed stream comprises for example, 20-60% by weight of the total amount of monomers a) and b).

Monomers a), b) and c) reacted in the first step shall be called monomers Ia), Ib) and Ic), monomers a), b) and c) reacted in the second step shall be called monomers IIa), IIb) and IIc).

In the second step the same types of monomers a), b) and optionally c) can be reacted as in the first stage, but it is also possible to use different types of monomers a), b) and c) in each stage. The monomers of monomer mixture I can also overlap with the monomers of monomer mixture II. With other words monomers Ia) and Ib) may be the same as monomers IIa) and IIb), may overlap with monomers IIa) and IIb) or may be different from monomers IIa) and IIb). The same applies to compound c), if also used in the second stage of the skew feed process.

The preparation of the hydroxy-functional (meth)acrylic copolymer in the first and second stage takes place by radical copolymerization. This may be carried out in a manner known to the skilled person by conventional processes, particularly by radical solution polymerization using radical initiators. Examples of suitable radical initiators are dialkyl peroxides, diacyl peroxides, hydroperoxides, such as, cumene hydroperoxide, peresters, peroxydicarbonates, perketals, ketone peroxides, azo compounds, such as, 2,2′-azo-bis-(2,4-dimethylvaleronitrile), azo-bis-isobutyronitrile, C—C-cleaving initiators, such as, e.g., benzpinacol derivatives. The initiators may be used in amounts from 0.1 to 4.0 wt-%, for example, based on the initial monomer weight.

The solution polymerization process is generally carried out in such a way that the solvent is charged to the reaction vessel, heated to the boiling point and the monomer/initiator mixture is metered in continuously over a particular period. Polymerization is carried out preferably at temperatures between 60° C. and 200° C. and more preferably at 130° C. to 180° C.

In the first stage polymerization is carried out in a way that at least 80%, preferably at least 90% of the monomer mixture I are polymerized. After addition of the second feed stream, which comprises the monomer mixture II) the reactor contents are typically rinsed with additional organic solvent, held for a period of time at reflux, and rinsed a final time with additional organic solvent.

Examples of suitable organic solvents which may be used advantageously in solution polymerization and also later in the coating compositions according to the invention include: glycol ethers, such as, ethylene glycol dimethylether; propylene glycol dimethylether; glycol ether esters, such as, ethyl glycol acetate, butyl glycol acetate, 3-methoxy-n-butyl acetate, butyl diglycol acetate, methoxy propyl acetate, esters, such as, butyl acetate, isobutyl acetate, amyl acetate; ketones, such as, methyl ethyl ketone, methyl isobutyl ketone; methyl amyl ketone, cyclohexanone, isophorone, aromatic hydrocarbons (e.g., with a boiling range from 136° C. to 180° C.) and aliphatic hydrocarbons. Chain transfer agents such as, e.g., mercaptans, thioglycolates, cumene or dimeric alpha methylstyrene may be used to control the molecular weight.

The hydroxyl groups of the hydroxy-functional (meth)acrylic copolymers obtained in the first stage are modified at least partially with lactones (component c). This takes place by means of an esterification reaction, which proceeds with ring opening of the lactone. Again, hydroxyl groups are formed in the terminal position during the reaction.

The hydroxy-functional (meth)acrylic copolymer I obtained in the first stage may be prepared by polymerizing the monomers Ia) and Ib) in the presence of lactone component c) or by polymerizing the monomers Ia) and Ib) separately and then adding lactone component c).

Hydroxy-functional (meth)acrylic copolymer I obtained in the first step have preferably an OH value from 100-170 mg KOH/g, a weight average molecular weight Mw from 2,500-25,000 and a glass transition temperature Tg of −20 to +40° C.

In the second stage monomers IIa) and IIb) are polymerized in presence of the hydroxy-functional (meth)acrylic copolymer I obtained in the first stage. It is possible, but not preferred to add a part of the lactone compound c) also in the second stage e.g. up to 30% by weight based on the entire amount of lactone compound c).

The hydroxy-functional (meth)acrylic copolymer obtained in the second stage has preferably an OH value from 130-190 mg KOH/g, a weight average molecular weight Mw from 2,500-20,000 and a glass transition temperature Tg of +20 to +80° C.

The final hydroxy-functional (meth)acrylic copolymer has preferably the OH value and weight average molecular weight Mw as mentioned above as well as a glass transition temperature Tg of −10 to +80° C.

The coating compositions according to the invention contain as component B) at least one cross-linking agent which is capable of entering into a cross-linking reaction with the OH-groups of components A). These may, for example, comprise polyisocyanates with free isocyanate groups, polyisocyanates with at least partially blocked isocyanate groups, amino resins and/or tris(alkoxycarbonylamino)triazines, such as, for example, 2,4,6-tris(methoxycarbonylamino)-1,3,5-triazine and 2,4,6-tris(butoxycarbonylamino)-1,3,5-triazine.

The polyisocyanates comprise, for example, any desired organic polyisocyanates having aliphatically, cycloaliphatically, araliphatically and/or aromatically attached free isocyanate groups. The polyisocyanates preferably comprise polyisocyanates or polyisocyanate mixtures having exclusively aliphatically and/or cycloaliphatically attached isocyanate groups with an average NCO functionality of 1.5 to 5, preferably of 2 to 4.

Particularly suitable compounds are, for example, so-called “coating polyisocyanates” based on hexamethylene diisocyanate (HDI), 1-isocyanato-3,5,5-trimethyl-5-isocyanatomethylcyclohexane (IPDI) and/or bis(isocyanatocyclohexyl)methane and the per se known derivatives of said diisocyanates comprising biuret, allophanate, urethane and/or isocyanurate groups. Triisocyanates, such as, triisocyanatononane may also be used.

Sterically hindered polyisocyanates are likewise also suitable. Examples of these are 1,1,6,6-tetramethylhexamethylene diisocyanate, 1,5-dibutylpentamethyl diisocyanate, p- or m-tetramethylxylylene diisocyanate and the corresponding hydrogenated homologues.

Diisocyanates may in principle be reacted in conventional manner to yield more highly functional compounds, for example, by trimerization or by reaction with water or polyols, such as, for example, trimethylolpropane or glycerol.

Corresponding prepolymers containing isocyanate groups may also be used as di- and/or polyisocyanates. The polyisocyanate cross-linking agents may be used individually or in combination.

Blocked or partially blocked polyisocyanates may also be used as the cross-linking component. Examples of blocked or partially blocked isocyanates are any desired di- and/or polyisocyanates, in which the isocyanate groups or a proportion of the isocyanate groups have been reacted with compounds that contain active hydrogen. These comprise, for example, polyisocyanates as have already been described above. Trifunctional, aromatic and/or aliphatic blocked or partially blocked isocyanates having a number average molar mass of for example, 500-1500 are preferred. Low molecular weight compounds containing active hydrogen for blocking NCO groups are known. Examples of these are aliphatic or cycloaliphatic alcohols, dialkylaminoalcohols, oximes, lactams, imides, hydroxyalkylesters, malonic acid or acetoacetic acid esters.

Amino resins are likewise suitable as cross-linking agents. These resins are produced in accordance with the prior art and are offered for sale as commercial products by many companies. Examples of such amino resins are amine/formaldehyde condensation resins which are obtained by reacting aldehydes with melamine, guanamine, benzoguanamine or dicyandiamide. The alcohol groups of the aldehyde condensation products are then partially or completely etherified with alcohols.

The coating compositions of the present invention may contain additional hydroxy-functional binders apart from the hydroxy-functional (meth)acrylic copolymers A). That means the resin solids of the coating composition according to the invention may comprise, in addition to components A) and B) additional hydroxy-functional binders. For example, the-additional hydroxy-functional binders may be hydroxy-functional binders well known to the skilled person, of the kind used for the formulation of solvent-based coating compositions. Examples of additional suitable hydroxy-functional binders include hydroxy-functional polyester, alkyd, polyurethane and/or poly(meth)acrylic resins which are different from the (meth)acrylic copolymers A). The additional hydroxy-functional binders may also be present in the modified form, e.g., in the form of (meth)acrylated polyesters or (meth)acrylated polyurethanes. They may be used on their own or in a mixture. The proportion of additional hydroxy-functional binders may be 0 to 40 wt-%, for example, based on the entire amount of hydroxy-functional (meth)acrylic copolymers A) and cross-linking agents B). The coating compositions may also contain low molecular weight reactive components, so-called reactive-diluents that are capable of reacting with the cross-linking agent. Examples of these include hydroxy- or amino-functional reactive diluents.

The hydroxy-functional (meth)acrylic copolymers A) and the cross-linking agents B) are used in each case in such quantity ratios that the equivalent ratio of hydroxyl groups of the (meth)acrylic copolymers A) to the functional groups of the cross-linking agent is 5:1 to 1:5, for example, preferably, 3:1 to 1:3, particularly preferably, 1.5:1 to 1:1.5. If further hydroxy-functional binders and reactive thinners are used, their reactive functions should be taken into consideration when calculating the equivalent ratio.

The coating compositions according to the invention contain organic solvents. The solvents may originate from the preparation of the binders or they may be added separately. They are organic solvents typical of those used for coatings and well known to the skilled person, for example, those already mentioned above for the preparation of solution polymers. The organic solvents may be present in amounts of e.g. 10 to 60% by weight, based on the entire coating composition.

The coating compositions according to the invention may contain pigments and/or fillers. Suitable pigments are all the conventional color-imparting and/or special effect-imparting coating pigments of an organic or inorganic nature.

The coating compositions may contain conventional coating additives. The additives are the conventional additives, which may be used, in the coating sector. Examples of such additives include light protecting agents, e.g., based on benzotriazoles and HALS compounds (hindered amine light stabilizers), leveling agents based on (meth)acrylic homopolymers or silicone oils, rheology-influencing agents, such as, fine-particle silica or polymeric urea compounds, thickeners, such as, partially cross-linked polycarboxylic acid or polyurethanes, anti-foaming agents, wetting agents, curing catalysts for the cross-linking reaction, for example, organic metal salts, such as,.dibutyltin dilaurate, zinc naphthenate and compounds containing tertiary amino groups, such as, triethylamine for the hydroxyl/isocyanate reaction.

Depending upon the type of cross-linking agent, single-component or two-component coating compositions may be formulated according to the invention. If polyisocyanates having free isocyanate groups are used as the cross-linking agent, the coating compositions are two-component systems, i.e., the binder components containing hydroxyl groups, optionally, together with pigments, extenders and conventional coating additives, and the polyisocyanate component may be mixed together only shortly before application. The coating compositions may, in principle, additionally be adjusted to spraying viscosity with organic solvents before being applied.

The coating compositions according to the invention may be applied by known methods, particularly by spraying. The coatings obtained may be cured at room temperature or by forced drying at higher temperatures, e.g., up to 80° C., preferably, at 20° C. to 60° C. They may also, however, be cured at higher temperature from, for example, 80° C. to 160° C.

The coating compositions according to the invention are suitable for automotive and industrial coating. In the automotive coating sector the coating agents may be used both for OEM (Original Equipment Manufacture) automotive coating and for automotive and automotive part refinishing. Stoving or baking temperatures from 80° C. to 140° C., for example, preferably from 110° C. to 130° C., are used for original automotive coating. Curing temperatures from 20° C. to 80° C., for example, particularly from 40° C. to 60° C. are used for automotive refinishing. The coating compositions can also be used in coating large vehicles, such as, trucks and busses.

The coating compositions according to the invention may be formulated as pigmented top coats or as transparent clear coats and used for the preparation of the outer pigmented top coat layer of a multi-layer coating or for the preparation of the outer clear coat layer of a multi-layer coating. The present invention also relates, therefore, to the use of the coating compositions according to the invention as a top coat coating composition (monocoat) and as a clear coat coating composition, and to a process for the preparation of multi-layer coatings, wherein in particular the pigmented top coat and transparent clear coat layers of multi-layer coatings are produced by means of the coating compositions according to the invention.

The coating compositions may be applied as a pigmented topcoat layer, for example, to conventional 1-component or 2-component primer surfacer layers. The coating compositions may be applied as transparent clear coat coating compositions, for example, by the wet-in wet method, to solvent-based or aqueous color- and/or special effect-imparting base coat layers. In this case, the color- and/or special effect-imparting base coat layer is applied to an optionally pre-coated substrate, particularly pre-coated vehicle bodies or parts thereof, before the clear coat coating layer of the clear coat coating compositions according to the invention is applied. After an optional flash-off phase, both layers are then cured together. Within the context of OEM automotive coating, flash-off may be carried out, for example, at 20° C. to 80° C. and within the context of refinishing over a period of 15 to 45 minutes at ambient temperature, depending on the relative humidity.

The coating compositions of the present invention may be used in particular advantageously as two-component clear coat and topcoat coating compositions in automotive refinishing. Top coat layers and clear coat layers with good scratch resistance and good hardness may be achieved in combination with an excellent physical drying performance. In addition, the coating layers show a very good appearance.

The invention will be explained in more detail on the basis of the examples below. All parts and percentages are on a weight basis unless otherwise indicated.

### EXAMPLES

### Copolymer Examples

### Example 1

### Preparation of Skew-Feed Acrylic Copolymer 1

### First Step:

In a reactor equipped with a propeller type of stirrer, a thermometer, condensor and monomer/initiator feeding system 70 grams of Xylene (X), 88 grams of caprolactone (CL) and 1 gram of a 10% solution of dibutyltin dilaurate (DBTDL) in n-butylacetate (BAC) were loaded and heated to about 165° C. A mixture of 192 grams of 2-Hydroxypropyl methacrylate (HPMA), 160 grams of Styrene (S), 80 grams of n-Butyl methacrylate (BMA), 10 grams of Di-tertiary butyl peroxide DTBP (Trigonox® B available from Akzo) and 45 grams of Solvesso® 100 (S100) were added over 2.5 hours to the reactor contents keeping 165° C. reflux temperature. After the feed 5 grams of S100 were added to rince and the reactor contents were kept for 8 hours at reflux. Next the reactor contents were thinned by adding 145 grams of X while keeping at reflux.

### Test results of the First Step Copolymer:

Solids: 66.3% (Determined at 105° C. for 1 hour)
Viscosity: Z1+¼ (Measured according Gardner-Holdt)
Acid value: 3.9 mg KOH/g
Mn/Mw=2700/8700 (Number and weight average molecular weight measured with GPC using polystyrene standards)
Hydroxyl value calculated (OH)=144 mg KOH/g
Glass transition temperature Tg=12° C. (Calculated according to Flory-Fox equation)

### Second Step:

In a next step 108 grams 2-Hydroxyethyl methacrylate (HEMA), 148 grams of Isobutyl methacrylate (IBMA), 24 grams of Acrylic acid (M), 5 grams of dicumylperoxide (DCP) (Perkadox BC available from Akzo) and 35 grams of S100 were added to the copolymer solution prepared in step 1 over 2.5 hours at about 145° C. reflux temperature. 5 grams of S100 were added and the reactor contents kept for 1 hour. In the next step 1 gram of DCP dissolved in 7 grams of S100 were added over 30 min followed by a rincing step of 1 gram of S100 and a hold period of 1 hour at reflux temperature. At the end, the reactor contents were cooled by adding 208 grams of BAC.

### Test Results of Final Copolymer:

Solids: 58.8% (Determined at 105° C. for 1 hour)
Viscosity: X-¼ (Measured according Gardner-Holdt)
Acid value: 28.5 mg KOH/g
Mn/Mw=3000/9400 (Number and weight average molecular weight measured with GPC using polystyrene standards)
Hydroxyl value calculated (OH)=152 mg KOH/g
Tg=25° C. (Calculated according to Flory-Fox equation)

### Test Results of Second Step Copolymer:

Hydroxyl value calculated (OH)=166 mg KOH/g
Tg=52° C. (Calculated according to Flory-Fox equation)

### Examples 2-4

### Preparation of Skew—Feed Acrylic Copolymer 24

The procedure of example 1 was followed only changing the monomer composition and the amount of organic solvent added to adjust for the solids content.

| Exam- | First step | | | | Second step | | | |
|---|---|---|---|---|---|---|---|---|
| ple | Styrene | BMA | HPMA | CL | IBMA | BMA | HEMA | AA |
| 2 | 20 | 10 | 24 | 11 | 17.7 | | 13.5 | 3.8 |
| 3 | 20 | 10 | 24 | 11 | | 18.5 | 13.5 | 3 |
| 4 | 20 | 6 | 24 | 15 | 18.5 | | 13.5 | 3 |

| Example | | | | | |
|---|---|---|---|---|---|
| final copolymer | Solids | AN | OH | Mn | Mw |
| 2 | 59.3 | 35 | 153 | 5300 | 20550 |
| 3 | 60.2 | 28 | 153 | 3100 | 7800 |
| 4 | 59.6 | 28 | 153 | 2900 | 9000 |

Example 2: Tg second step copolymer: +53° C. Tg final copolymer: +26 C.
Example 3: Tg second step copolymer: +39° C. Tg final copolymer: +2° C.
Example 4: Tg second step copolymer: +52° C. Tg final copolymer: +16 C.
AN: acid number,
OH: hydroxyl number,
Tg: glass transition temperature (calculated according to Flory-Fox equation)

### Comparative Example 1

### Preparation of Skew Feed Acrylic Copolymer Without Caprolactone Grafting (According to Process Described in EP 0095627)

The procedure of example 1 was followed only changing the monomer composition in the first step to a copolymer without caprolactone at the same overall calculated Tg and hydroxyl value.

### First Step:

In a reactor equipped with a propeller type of stirrer, a thermometer, condensor and monomer/initiator feeding system 70 grams of S100 and 1 gram of a 10% solution of (DBTDL) in BAC were loaded and heated to about 165° C. A mixture of 192.4 grams of (HPMA), 135.2 grams of S, 192.4 grams of n-Butyl acrylate (BA), 10 grams of (DTBP) (Trigonox® B available from Akzo) and 49 grams of Solvesso® 100 (S100) were added over 2.5 hours to the reactor contents keeping 165° C. reflux temperature. After the feed, 5 grams of S100 were added to rince and the reactor contents were kept for 2 hours at reflux. Next the reactor contents were thinned by adding 145 grams of X while keeping at reflux.

### Test Results of the First Step Copolymer:

Solids: 66.8% (Determined at 105° C. for 1 hour)
Viscosity: Z1−¼ (Measured according to Gardner-Holdt)
Acid value: 3.9 mg KOH/g
Mn/Mw=3600/9100 (Number and weight average molecular weight measured with GPC using polystyrene standards)
Hydroxyl value calculated (OH)=144 mg KOH/g
Glass transition temperature Tg=12° C. (Calculated according Flory-Fox equation)

In a next step 108 grams (HEMA), 148 grams of (IBMA), 24 grams of (AA), 5 grams of DCP (Perkadox BC available from Akzo) and 35 grams of S100 were added over 2.5 hours at about 145 C reflux temperature. 5 grams of S100 were added to the copolymer solution prepared in step 1 and the reactor contents kept for 1 hour. In the next step 1 gram of (DCP) dissolved in 7 grams of S100 were added over 30 min followed by a rincing step of 1 gram of S100 and a hold period of 1 hour at reflux temperature. At the end, the reactor contents were cooled by adding 208 grams of BAC.

### Test Results:

The polymer solution phase separated and could not be tested for solids/viscosity.

### Final Copolymer:

Mn/Mw=3400/10700 (Number and weight average molecular weight measured with GPC using polystyrene standards)
Hydroxyl value calculated (OH)=152 mg KOH/g
Tg=25° C. (Calculated according Flory-Fox equation)

### Second Step Copolymer:

Hydroxyl value calculated (OH)=166 mg KOH/g
Tg=52° C. (Calculated according Flory-Fox equation)

### Comparative Example 2

### Preparation of a Random Acrylic Copolymer With Overall Composition as Example 1

In a reactor equipped with a propeller type of stirrer, a thermometer, condensor and monomer/initiator feeding system 70 grams of S100, 88 grams of (CL) and 1 gram of a 10% solution of (DBTDL) in (BAC) were loaded and heated to about 165°. A mixture of 192 grams of (HPMA), 160 grams of (S), 80 grams of (BMA), 148 grams of (IBMA), 108 grams of (HEMA), 24 grams of (AA), 10 grams of DTBP (Trigonox® B available from Akzo), 5 grams of DCP (Perkadox BC from Akzo), 45 grams of (X) and 84 grams of (S100) were added over 5 hours to the reactor contents keeping 165° C. reflux temperature. After the feed, 10 grams of S100 were added to rince and the reactor contents were kept for 8 hours at reflux. Next the reactor contents were cooled by adding 100 grams of X and 208 grams of (BAC).

### Test Results:

Solids: 59.9% (Determined at 105° C. for 1 hour)
Viscosity: U-¼ (Measured according Gardner-Holdt)
Acid value: 24.3 mg KOH/g
Mn/Mw=2200/7500 (Number and weight average molecular weight measured with GPC using polystyrene standards)
Hydroxyl, value calculated (OH)=152 mg KOH/g
Tg=25° C. (Calculated according Flory-Fox equation)

### Comparative Example 3

### Separate Synthesis of the Acrylic Copolymer of Step 2 of Example 1

In a reactor equipped with a propeller type of stirrer, a thermometer, condensor and monomer/initiator feeding system 75 grams of X were loaded.

Then 108 grams (HEMA), 148 grams of (IBMA), 24 grams of (AA), 5 grams of DCP (Perkadox

BC available from Akzo) and 35 grams of S100 were added over 2.5 hours at about 145° C. reflux temperature. 5 grams of S100 were added and the reactor contents kept for 1 hour. In the next step 1 gram of DCP dissolved in 7 grams of S100 were added over 30 min followed by a rincing step of 1 gram of S100 and a hold period of 1 hour at reflux temperature. At the end, the reactor contents were cooled by adding 208 grams of BAC.

Immediately after the start of the monomer feed, the formed polymer precipitated out so that the complete procedure could not be finished.

### Coating Examples

A commercial clearcoat has been used based on a one-step hydroxyl functional (meth)acrylic-copolymer without ε-caprolactone has been used as standard clearcoat for comparative purposes.

Clearcoats according to the invention (CC1 with resin example 1, CC2 with resin example 2, CC3 with resin example 3, CC4 with resin example 4), the standard clearcoat (ST CC with the hydroxyl functional 1-step acrylic, without ε-caprolactone) and the comparative clearcoat (Comp CC2 with resin comparative example 2) have been formulated with the ingredients shown in Table 1 below.

TABLE 1

| | | Examples | | |
|---|---|---|---|---|
| | Composition | ST CC | CC 1–4, Comp CC2 | |
| Resin | Hydroxyl functional acrylic | 83.29 | | |
| | (without ε-caprolactone) | | | |
| | Resin example 1–4 | | 66.0 | |
| | Resin comparative | | | 66.0 |
| | example 2 | | | |
| Solvents | Methyl isobutyl ketone | 3.42 | 7.66 | 7.66 |
| | Primair amyl acetate | 2.36 | 6.13 | 6.13 |
| | Ethyl-3-ethoxyproprionate | 3.43 | 8.44 | 8.44 |
| | Propylene glycol methyl | 0.68 | 1.67 | 1.67 |
| | ether acetate | | | |
| | Ethylene glycol | 1.73 | 4.23 | 4.23 |
| | monobutylether | | | |
| | Butylacetate | 1.80 | 2.05 | 2.05 |
| Additives | Byk ® 306 | 0.05 | | |
| | (Byk Chemie) (1) | | | |
| | Byk ® 332 | 0.05 | | |
| | (Byk Chemie) (1) | | | |
| | Byk ® 361 | 0.2 | | |
| | (Byk Chemie) (1) | | | |
| | Byk ® 310 | | 0.17 | 0.17 |
| | (Byk Chemie) (1) | | | |
| | Byk ® 358 | | 0.28 | 0.28 |
| | (Byk Chemie) (2) | | | |
| Catalysts | DBTDL | 1.49 | 0.85 | 0.85 |
| | (1% in Xylene) | | | |
| UV- | Tinuvin ® 292 | 0.3 | 0.64 | 0.64 |
| stabilizers | (Ciba Geigy) | | | |
| | Tinuvin ® 1130 | 0.6 | 1.29 | 1.29 |
| | (Ciba Geigy) | | | |
| Potlife | Acetic acid | 0.6 | 0.59 | 0.59 |
| extender | (50% in Xylene) | | | |

(1) wetting additive
(2) leveling additive

A commercial polyisocyanate activator based on Desmodur® 3390 (Bayer AG) has been used. The NCO/OH ration was kept constant at 1.2.

Standard metal panels, on which a commercial primer and a commercial waterborne basecoat had been applied, were coated with the clear coats. The clear coats were applied in a dry film thickness of 50 μm and baked for 30 minutes at 60° C.

The technological properties of the clear coat formulations are shown in Table 2 below.

TABLE 2

| | | ST | | | | | Comp |
|---|---|---|---|---|---|---|---|
| Clear Coat | | CC | CC1 | CC2 | CC3 | CC4 | CC2 |
| Appear.: | | | | | | | |
| Initial gloss | | 93.4 | 88.4 | 88.2 | 88.4 | 88.2 | 87.3 |
| at 20A | | | | | | | |
| Initial D.O.I. | | 95.4 | 95.2 | 93.3 | 95.9 | 95.2 | 93.6 |
| Scratch-Test (GB) | | | | | | | |
| Residual | | 28.2 | 41.2 | 43.7 | 41.1 | 41.8 | 42.8 |
| gloss at 20A | | | | | | | |
| Gloss after | | 50.0 | 69.5 | 72.1 | 71.8 | 74.4 | 73.4 |
| Reflow (60′, 60° C.) | | | | | | | |
| Scratch-Test (Amtec) | | | | | | | |
| Residual | | 18.1 | | | | 42.0 | 51.6 |
| gloss at 20A | | | | | | | |
| Gloss after | | 30.9 | | | | 62.7 | 72.4 |
| Reflow (60′, 60° C.) | | | | | | | |
| Drying: | | | | | | | |
| TACK warm/cold | | 10/10 | 10/10 | 10/10 | 8/9–10 | 7/9–10 | 7/8 |
| TAPE free | | | | | | | |
| time | 10′ | 2/3 | 3/4 | 3/4 | 2/3 | 2/3 | 2/3 |
| | 60′ | 2/4 | 4/5 | 4/7 | 2/4 | 3/4 | 3/4 |

| | | | | | | |
|---|---|---|---|---|---|---|
| Fisher Hardness: | | | | | | |
| initial | 1.9 | 1.7 | 2 | 1.2 | 1.7 | 0.2 |
| after 4 hours | 2.5 | 2.7 | 3.2 | 2.2 | 2.7 | 0.2 |
| after 1 day | 8.4 | 10 | 9.6 | 9.8 | 10.3 | 5.5 |
| after 1 week | 15.0 | 14.1 | 13.7 | 13.8 | 14.1 | 12.0 |

Appear. = Appearance
20A = angle of 20°

Scratch resistance of the clear coats according to invention has remarkable been increased compared with the standard clear coat, while maintaining a very good hardness and appearance. Comparative clear coat 2 has shown similar good scratch resistance as the clear coats according to invention, but had only insufficient drying properties and initial hardness as well as final hardness.

### Test Methods Used:

### Appearance:

Gloss is measured with a Byk gloss meter. DOI is measured with a Byk Wavescan device.

### Drying:

Tack: Standard metal panels (10×30 cm) are clear coated (dry film thickness of 50 μm) and baked horizontally for 30 minutes at 60° C. Immediately after bake, the panel, which is still warm, is touched with a paper and the degree of tackiness (=stickiness) is rated.

Rating scale from 10 till 0, with 10 best (no tackiness at all) and 0 totally unacceptable (very sticky). After 10 minutes cool down the test is repeated.

Tape free: Standard metal panels (10×30 cm) are clear coated (dry film thickness of 50 μm) and baked horizontally for 30 minutes at 60° C. After a 10 minutes cool down period a strip of masking tape is applied across the panel, smoothing it out manually using moderate firm pressure to insure uniform contact. A 2 kg weight is rolled over the tape to and fro. After 10 minutes the tape is removed and the degree of marking is evaluated (first rating). After 30 minutes recovery, the tape imprint is evaluated again (second rating). After a 60 minute cool down period, a second strip of masking tape is applied across the panel and the procedure is repeated as described above. The evaluation is done according to ASTM D1640-83.

### Scratch Resistance:

### Gardner-Brush (GB)

The clear coated panels are scratched after 7 days using the linear Gardner brush test (nylon brush) (according to ASTM D2486-89) where an abrasive medium based on quartz (Sikron SH 2000 from Quarzwerke, 1.5 g/l in water) is used. Each panel undergoes 120 brush cycles. The gloss before and after scratching is measured (Byk gloss meter).

### Amtec:

The clear coated panels are scratched after 7 days using the Amtec car wash test ( polyethylene brush) (according to DIN 55668) where an abrasive medium based on quartz (Sikron SH 200 from Quarzwerke, 1.5 g/l in water) is used. Each panel undergoes 10 brush cycles. The gloss before and after scratching is measured (Byk gloss meter).

### Hardness Development:

Glass panels are clear coated (dry film thickness of 50 μm) and baked horizontally for 30 minutes at 60° C. After a 30 minutes cool down period the Fisher hardness is measured. This measurement is repeated after 4 hours, 1 day and after 1 week.

What is claimed is:

1. A solvent-based coating composition having a resin solids, said resin solids comprising
A) 10-90% by weight of at least one hydroxyl-functional (meth)acrylic copolymer and
B) 90-10 weight.-% of at least one cross-linking agent which is capable of entering into a cross-linking reaction with the OH-groups of components A), wherein the % by weight of component A) and B) add up to 100 weight.-%,
wherein the hydroxyl-functional (meth)acrylic copolymer A) is obtained by reacting a group of components, comprising
a) 15-50% by weight of at least one hydroxy functional free-radically copolymerizable olefinically unsaturated monomer,
b) 30-80% by weight of at least one non-hydroxy functional polymerisable unsaturated monomer and
c) 5-40% by weight of at least one lactone compound, wherein the % by weight of components a), b) and c) add up to 100% by weight, and
wherein the hydroxy-functional (meth)acrylic copolymer A) is prepared by reacting monomers a), b) and c) in a skew feed polymerization process, with at least two feed streams,
wherein in a first stage a monomer mixture I) comprising 30-40% by weight of monomers a), 40-70% by weight of monomers b) and 10-30% by weight of compounds c) is reacted, wherein the % by weight of components a), b) and c) are based on the entire amount of monomer mixture I) used in the first stage add up to 100% by weight,
and wherein in a second stage a monomer mixture II) comprising 30-50% by weight of monomers a) and 40-70% by weight of monomers b), wherein the % by weight of components a) and b) are based on the entire amount of monomer mixture II) used in the second stage add up to 100 weight.-%, is polymerized in presence of the copolymer obtained in the first stage.

2. The coating composition according to claim 1, wherein the hydroxy-functional (meth)acrylic copolymer A) comprises 30-40% by weight of component a), 40-70% by weight of component b) and 10-30% by weight of component c), wherein the % by weight of components a), b) and c) add up to 100 weight.-%,

3. The coating composition according to claim 1, wherein the hydroxy-functional (meth)acrylic copolymer A) has an OH value from 80 to 200 KOH/g and a weight average molecular weight Mw from 2,500 to 30,000.

4. The coating compositions according to claim 1, wherein the hydroxy-functional (meth)acrylic copolymer A) has an OH value from 150-190 mg KOH/g, a weight average molecular weight Mw from 3,000 to 20,000.

5. The coating compositions according to claim 1, wherein the hydroxy-functional (meth)acrylic copolymer obtained in the first stage has an OH value from 100-170 mg KOH/g, a weight average molecular weight Mw from 2,500 to 25,000 and a glass transition temperature Tg from −20° C. to 40° C.

6. The coating compositions according to claim 1, wherein the hydroxy-functional (meth)acrylic copolymer obtained in the second stage has an OH value from 130-190 mg KOH/g, a weight average molecular weight Mw from 2,500 to 20,000 and a glass transition temperature Tg from 20° C. to 80° C.

7. The coating compositions according to claim 1, wherein component b) comprises
b1) at least one alkyl ester of an olefinically unsaturated carboxylic acid with 2-12 C atoms in the alkyl residue,
b2) of at least one vinylaromatic olefinically unsaturated monomer,
b3) of at least unsaturated acid functional monomer and
b4) of at least one other polymerisable unsaturated monomer which is different from components b1) to b3).

8. The coating compositions according to claim 7, wherein component b) consist of 10-90% by weight of component b1), 0-50% by weight of component b2), 0-10% by weight of component b3) and 0-30% by weight of component b4), wherein the % by weight of components b1) to b4) add up to 100% by weight.

9. The coating compositions according to claim 7, wherein component b) consist of 20-80% by weight of component b1), 10-40% by weight of component b2), 2-6% by weight of component b3) and 0-20% by weight of component b4), wherein the % by weight of components b1) to b4) add up to 100% by weight.

10. The coating composition according to claim 1, in which component c) is epsilon-caprolacton.

11. A process which comprises applying a multi-layer coating on a substrate using a coating composition according to claim 1 and curing said coating.

12. A process for multi-layer coating of substrates by applying a top coat layer to a substrate pre-coated with one or more coating layers, wherein the top coat layer composed of a color- and/or special effect-imparting base coat coating compound and a clear coat coating compound is applied, and wherein the clear coating layer is composed of a coating composition according to claim 1.

13. A process for multi-layer coating of substrates by applying a top coat layer to a substrate pre-coated with one or more coating layers, wherein the top coat layer composed of a pigmented one-layer top coat coating compound is applied, and wherein the pigmented one-layer top coat coating layers is composed of a coating composition according to claim 1.

14. The process according to claim 11, wherein the substrates are selected from the group consisting of automotive bodies and automotive body parts.
